(19) United States
(12) Patent Application Publication
(10) Pub. No.: US 2020/0169785 A1
(43) Pub. Date: May 28, 2020

(54) SYSTEMS AND METHODS FOR DYNAMICALLY MODIFYING IMAGE AND VIDEO CONTENT BASED ON USER PREFERENCES

(71) Applicant: Capital One Services, LLC, McLean, VA (US)

(72) Inventors: Jeremy GOODSITT, Champaign, IL (US); Anh TRUONG, Champaign, IL (US); Fardin Abdi Taghi ABAD, Champaign, IL (US); Mark WATSON, Urbana, IL (US); Reza FARIVAR, Champaign, IL (US); Austin WALTERS, Savoy, IL (US)

(21) Appl. No.: 16/202,942

(22) Filed: Nov. 28, 2018

(51) Int. Cl. H04N 21/454; H04N 21/258; G06N 3/08; H04N 21/81; H04N 21/25

(52) U.S. Cl. CPC H04N 21/454; H04N 21/25883; H04N 21/25891; H04N 21/251; H04N 21/812; H04N 21/8146; G06N 3/08

(57) ABSTRACT

Embodiments disclosed herein provide for dynamically modifying image and/or video content based on user preferences. The system and methods provide for a plurality of generative adversarial networks, each associated with a corresponding style transfer, wherein each style transfer is configured to uniquely transform a content template based on distinct user preference information.

### TECHNICAL FIELD

The present application relates to a system and method for dynamically modifying image and/or video content based on user preferences.

### BACKGROUND

Targeted advertising, as its name implies, refers to the targeting of advertising to specific audiences. For example, children may prefer anime or cartoon advertisements. On the other hand, adults might prefer a live-action advertisement. Currently, online advertisers are able to target their advertisements to a particular user based on the user's personal preference or information. Specifically, online advertisers provide targeted advertisements to a particular user based on the user information collected and stored by the user's web browser. In particular, the online advertisers access the information stored in browser cookies. A browser cookie is a small piece of information provided by the website to the browser as the user browses the website. Further, browser cookies are generally stored by the browser at the user's computer. Browser cookies can store information regarding the user's browser activity as well as any personal information entered by the user at the website. As such, based on the browser cookie, the online advertiser can determine a lot of specific information about a user, such as the user's age, location, etc. Then, based on such information, the online advertiser may provide a targeted advertisement to the user. For example, if it is determined by the online advertiser that the user is a child, the provided advertisement may be either a cartoon, anime, or some other computer-animated content. Currently, however, the provided advertisements have to be pre-made. Further, once they're made, there is currently no means of modifying the content of the advertisements after such user preference information is determined.

Accordingly, there is a need for dynamically generating image and video content based on specific user preferences.

### BRIEF DESCRIPTION OF THE DRAWINGS

FIG. 1A illustrates an example embodiment of a system employing dynamic modification of image and video content.

FIG. 1B illustrates an example embodiment of the content generator depicted in FIG. 1A.

FIG. 1C illustrates an example embodiment of the generative adversarial network associated with each style transfer in FIG. 1B.

FIG. 2A illustrates another example embodiment of a system employing dynamic modification of image and video content.

FIG. 2B illustrates an example embodiment of the server depicted in FIG. 2A.

FIG. 3 illustrates an example embodiment of a method for dynamically modifying image and video content.

### DESCRIPTION OF EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

One aspect of the present disclosure is to provide a system and method for dynamically modifying image and/or video content based on user preferences. The systems and methods herein address at least one of the problems discussed above.

According to an embodiment, a system for dynamically modifying content based on user preferences includes: a processor; a server; a memory database; and a content generator, wherein the content generator includes a plurality of generative adversarial networks, wherein each generative adversarial network is associated with a corresponding style transfer; wherein: (i) the processor is configured to generate a request for customized content from the server, (ii) the server is configured to: query the memory database for user preference information and a content template for the customized content, and request the customized content from the content generator based on the user preference information and the content template, and (iii) the content generator is configured to apply a certain style transfer to the content template to generate the customized content based on the user preference information.

According to an embodiment, a method for dynamically modifying content based on user preferences includes generating, at a processor, a request for customized content from a server; querying, with the server, a memory database for user preference information and a content template for the customized content; requesting, with the server, the customized content from a content generator based on the user preference information and the content template; and applying, at the content generator, a certain style transfer, of a plurality of style transfers, to the content template to generate the customized content based on the user preference information.

According to an embodiment, a system for dynamically modifying content based on user preferences includes a mobile device and a server, wherein the mobile device includes a processor, wherein the processor is configured to generate a request for customized content from the server upon determining that a user accessed certain content at the mobile device, wherein the server includes a plurality of generative adversarial networks, wherein each generative adversarial network is associated with a corresponding style transfer, wherein the server is configured to apply a certain style transfer to a content template to generate the customized content based on user preference information.

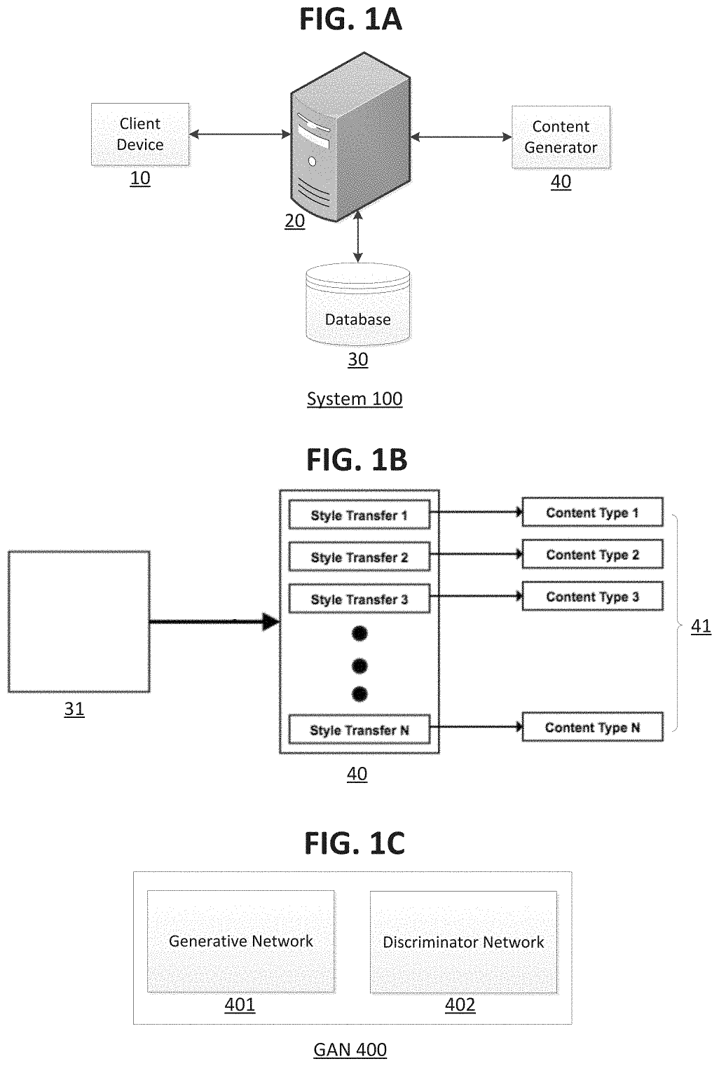

FIG. 1A illustrates an example embodiment of a system employing dynamic modification of image and video content. In an embodiment, as depicted in the figure, a system 100 includes a client device 10, a server 20, a database 30, and a content generator 40. In an embodiment, the client device 10 may be a mobile device, e.g., smart phone, tablet, personal computer, etc. The client device 10 may include a processor. In an embodiment, the processor is suitable for the execution of a computer program and may include, by way of example, both general and special purpose microprocessors, and any one or more processors of any kind of digital computer. Further, the client device 10 is configured to receive specific user input. For example, the client device 10 may be configured to access and browse content such as a website, a television channel, or a video game. Further, in an embodiment, after the user accesses said content, the client device 10 may provide additional content to the user, e.g., an advertisement. The additional content may be activated automatically by the client device 10 (e.g., via the processor). In another embodiment, the additional content may be activated intentionally by the user (e.g., by intentionally “playing” the additional content on the client device 10). Further, in an embodiment, the additional content may be provided to the user via a display and speakers. In an embodiment, the display may be a liquid crystal display (LCD), e.g., thin-film-transistor (TFT) LCD, in-place switching (IPS) LCD, capacitive or resistive touchscreen LCD, etc. Further, the display may also be an organic light emitting diode (OLED), e.g., active-matrix organic light emitting diode (AMOLED), super AMOLED, etc. Further, the server 20 may be a back-end component and may be configured to interact with each of the client device 10, the database 30, and the content generator 40 to provide generated content to display at the client device 10. For example, the server 20 may receive a request for customized content from the client device 10, query the memory database 30 for user preference information and a content template, and request customized content from the content generator 40 based on the user preference information and the content template. Further, the server 20 may also receive the receive the generated customized content from the content generator 40, and then transmit the generated customized content to the client device 10. In an embodiment, the memory database 30 is configured to store user preference and personal information. For example, the memory database 30 is configured to store browser cookies. Further, the memory database 30 is also configured to a plurality of content templates to be used in generating the additional content with the content generator 40. In an embodiment, the content template may be a live video. In another embodiment, the content template may be a bare-bones image. For example, the content template may be an image that only includes stick figures. In an embodiment, the content generator 40 is configured to generate the additional content based on the content template and the user information. In particular, the content generator 40 is configured to generate the additional content by applying a certain style transfer, of a plurality of style transfers, to the content template based on user information, wherein each style transfer is associated with distinct user preference information. For example, the distinct user preference information may correspond to an age range of a user, e.g., children, adults, etc. In an embodiment, the style transfers uniquely transform a content template to another format, e.g., (i) stick figures to cartoons, (ii) stick figures to anime, or (iii) stick figures to live-action. Similarly, the style transfers may also transform a live-action content template to a cartoon, anime, or a slightly different version of the live-action content template (e.g., the generated content may include different colors, images, etc.). For example, a plurality of style transfers may be associated with different hair colors or facial hair. Therefore, a style transfer associated with children may convert a content template to a cartoon or anime, while a style transfer associated with adults may convert the content template to a live-action advertisement. In an embodiment, each of the style transfers is trained with a distinct pre-built model. Specifically, each of the style transfers are trained with distinct generative adversarial networks (GANs). In an embodiment, a GAN includes a generative network and a discriminator network. In an embodiment, the generative network creates new content and the discriminator network determines if the content generated by the generative network is a real image or the generated content. After a period of time, the generative network is able to generate content that can deceive the discriminator network into determining that the generated content is a real image. In an embodiment, the content determined to be real is then output to be provided back to the client device 10. In an embodiment, the GAN can be trained on paired or unpaired data. In a paired dataset, every inputted image (e.g., stick figures) is manually mapped to an image in a target domain (e.g., cartoon, anime, live-action, etc.). Therefore, with a paired dataset, the generative network takes an input and maps the input image to an output image, which must be close to its mapped counterpart. However, with unpaired datasets, a cycle-consistent GAN may be utilized. With cycle-consistent GANs, after a first generative network transforms a given image from a first domain (e.g., stick figures) to a target domain (e.g., cartoon, anime, live-action, etc.), a second generative network then transforms the newly generated image from the target domain to the first domain. By transforming the generated image from the target domain to the first domain, a meaningful mapping between the input and output images can be defined for unpaired datasets.

FIG. 1B illustrates an example embodiment of the content generator depicted in FIG. 1A. As depicted in the figure, the content generator 40 receives a content template 31 in order to generate a plurality of content types 41 (e.g., cartoon, anime, live-action, blonde hair color, brunette hair color, gray hair color, mustache, goatee, variety of color palette schemes, etc.). Specifically, the content generator 40 applies a certain style transfer (e.g., style transfer 1, style transfer 2, style transfer 3, . . . style transfer N) to the content template 31 in order to generate a corresponding content type 41 (e.g., content type 1, content type 2, content type 3, . . . content type N). In an embodiment, the content template 31 can be a video or an image. If the content template is an image, a style transfer is applied to that individual image. However, if the content template is a video, the style transfer may be applied to each individual video frame of the content template. For example, the style transfer can be applied to each video frame consecutively. However, in another embodiment, the style transfer can be applied simultaneously to a number of video frames. For example, in an embodiment, because each frame transformation image can be considered independent of the other image transformation processes within the video, if multiple parallel systems are running with the same style transfer, each individual frame can be processed in parallel. In an embodiment, each of the style transfers 1 to N are associated with a distinct GAN. However, in another embodiment, each of the style transfers 1 to N can be associated with multiples GAN. In other words, a particular style transfer can be composed of a series of other style transfers.

FIG. 1C illustrates an example embodiment of the generative adversarial network associated with each style transfer in FIG. 1B. As depicted in the figure, a GAN 400 includes a generative network 401 and a discriminator network 402. As described above, the generative network 401 creates new content and the discriminator network 402 determines if the content generated by the generative network 401 is a real image or the generated content. Further, after a period of time, the generative network 401 is able to generate content that can deceive the discriminator network 402 into determining that the generated content is a real image.

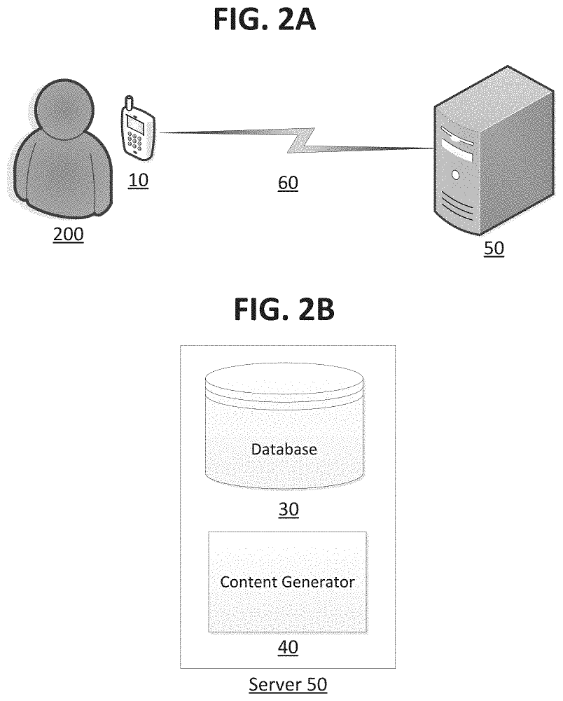

FIG. 2A illustrates another example embodiment of a system employing dynamic modification of image and video content. In an embodiment, FIG. 2A depicts a user 200 using the client device 10 as well as a server 50. In an embodiment, the client device 10 may communicate with the server 50 by any form or medium of digital data communication, e.g., a communication network 60. Examples of a communication network 60 include a local area network (LAN) and a wide area network (WAN), e.g., the Internet. In an embodiment, the server 50 is similar to 20 except that it also includes the database 30 and the content generator 40 as depicted in FIG. 2B.

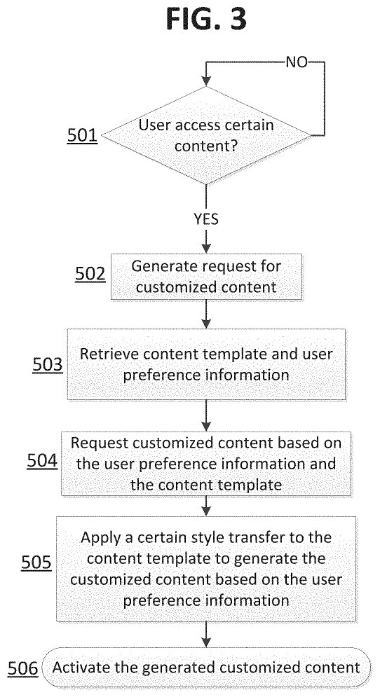

FIG. 3 illustrates an example embodiment of a method for dynamically modifying image and video content. As depicted in the figure, in a first step 501, it is determined if a certain user (e.g., user 200) accesses certain content (e.g., website, television channel, video game, etc.) at the client device 10. If the answer to step 501 is yes, then the method proceeds to step 502. Otherwise, the method stays on step 501. In step 502, the client device 10 generates and transmits a request for customized content 41 from the server 20 (or the server 50). Then, in step 503, based on the request for customized content 41 from the client device 10, the server 20 (or the server 50) queries and retrieves the content template 31 and user preference information from the memory database 30. In an embodiment, as described above, the user preference information can be accessed from browser cookies stored on the memory database 30. For example, the server 20 (or the server 50) may retrieve browser activity as well as other personal information indicating the user 200's age. Then, in step 504, the server 20 (or the server 50) requests the customized content 41 from the content generator 40 based on the user preference information (e.g., age) and the content template 31. Then, in step 505, based on the user preference information, the content generator 40 applies a corresponding style transfer to the content template 31 to generate the customized content 41. For example, if the user preference information indicates that the user 200 is a child, a style transfer associated with one of a cartoon or anime transformation may be applied to the content template 31. The generated customized content 41 is then transmitted back to the client device 10, where it may be activated by the client device 10 as described in step 506. As such, the generated customized content 41 may then be displayed to the user 200.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

In the foregoing Description of Embodiments, various features may be grouped together in a single embodiment for purposes of streamlining the disclosure. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Description of Embodiments, with each claim standing on its own as a separate embodiment of the invention.

Moreover, it will be apparent to those skilled in the art from consideration of the specification and practice of the present disclosure that various modifications and variations can be made to the disclosed systems without departing from the scope of the disclosure, as claimed. Thus, it is intended that the specification and examples be considered as exemplary only, with a true scope of the present disclosure being indicated by the following claims and their equivalents.

1. A system for dynamically modifying content based on user preferences, the system comprising:
a database containing user preference information and one more content templates; and
a plurality of generative adversarial networks, wherein each generative adversarial network is associated with a corresponding style transfer,
wherein the plurality of generative adversarial networks are configured to apply a style transfer to a content template obtained from the database by a database query to generate customized content based on user preference information obtained from the database by the database query,
wherein the database query is generated in response to a customized content request.

2. The system of claim 1, further comprising a server, wherein the server is configured to:
receive the generated customized content, and
transmit the generated customized content.

3. The system of claim 1, wherein each generative adversarial network is a cycle-consistent generative adversarial network.

4. The system of claim 1, wherein each generative adversarial network: (i) includes a generative network and a discriminator network and (ii) is trained on distinct training data.

5. The system of claim 1, wherein the style transfer is one of a live-action modification to the content template, an animated modification to the content template, and at least one color modification to the content template.

6. The system of claim 5, wherein the content template includes a plurality of video frames, wherein the style transfer is applied to each video frame of the content template.

7. The system of claim 6, wherein the style transfer is applied to at least two video frames simultaneously.

8. The system of claim 1, wherein the style transfer is associated with distinct user preference information, wherein the distinct user preference information corresponds to an age range of a user.

9. The system of claim 1, wherein at least two generative adversarial networks are associated with a particular style transfer.

10. A method for dynamically modifying content based on user preferences, the method comprises:
providing a content generator comprising a plurality of generative adversarial networks;
associating each of the plurality of generative adversarial networks with a style transfer;
querying a memory database for user preference information and a content template for customized content;
requesting the customized content from the content generator based on the user preference information and the content template; and
applying, at the content generator, a certain style transfer, of a plurality of style transfers, to the content template to generate the customized content based on the user preference information.

11. The method of claim 10, further comprising:
receiving the generated customized content, and
transmitting the generated customized content to the processor.

12. The method of claim 11, further comprising:
activating the generated customized content, wherein the activating includes displaying the generated customized content to a user.

13. The method of claim 12, further comprising:
deleting the generated customized content after the generated customized content is displayed to the user.

14. The method of claim 10, wherein the request for customized content is generated upon determining that a user accessed certain content, wherein the certain content is one of a website, a television channel, or a video game.

15. The method of claim 10, wherein each style transfer is associated with distinct user preference information.

16. The method of claim 15, wherein the content template includes a plurality of video frames, wherein the style transfer is applied to each video frame of the content template.

17. The method of claim 16, wherein the style transfer is applied to at least two video frames simultaneously.

18. The method of claim 10, wherein the content template is one of a video or an image.

19. The method of claim 18, wherein the video is live-action.

20. A system for dynamically modifying content based on user preferences, the system comprising:
a mobile device; and
a server;
wherein the mobile device includes a processor, wherein the processor is configured to generate a request for customized content from the server upon determining that a user accessed certain content at the mobile device;
wherein the server is configured to query a database containing user preference information and one more content templates based on the request for customized content,
wherein the server includes a plurality of generative adversarial networks comprising a content generator,
wherein each generative adversarial network is associated with a corresponding style transfer, and
wherein the content generator applies a certain style transfer to a content template obtained from the database by the query to generate the customized content based on user preference information obtained from the database by the query.
